(19) United States
(12) Patent Application Publication
(10) Pub. No.: US 2005/0216411 A1
(43) Pub. Date: Sep. 29, 2005

(54) Payor identification at the point of transaction

(76) Inventor: Patrick Thomas McQuary, San Antonio, CA (US)

Correspondence Address: Mr. Patrick Thomas McQuary, 29 Orsinger Hill, San Antonio, TX, 78230, US

(21) Appl. No.: 10/811,660

(22) Filed: Mar. 29, 2004

(51) Int. Cl. G06F 17/60

(52) U.S. Cl. 705/45

(57) ABSTRACT

The invention provides a method of accurately identifying the payor of a negotiable instrument by superimposing an identical image of a photographic government identification card on the personal checks of the payor. Then, when the payor presents the check to the merchant payee, accompanied by payor's own photographic government identification card, the merchant can rapidly compare the identification card with the copy of said identification card superimposed on the negotiable instrument.

### REFERENCES CITED [REFERENCED BY]

### U.S. Patent Documents

| | | | |
|---|---|---|---|
| 5,426,281 | Jun. 20, 1995 | Abecassis | 235/379 |
| 5,703,344 | Dec. 30, 1997 | Bezy, et al. | 235/379 |
| 6,192,142 | Feb. 20, 2001 | Pare, Jr., et al | 382/115 |

### FIELD OF INVENTION

This invention relates to the field of personal identification in financial transactions. Specifically, this invention is directed towards a system and method of identification of a payor of a negotiable instrument by means of comparing the payor's government issued photographic identification card with an exact image of same that has previously been superimposed by the payor's financial institution the negotiable instrument being presented by said payor

### BACKGROUND

The present invention relates to accurate identification at the point of transaction of the payor presenting a check to a merchant. Merchants and other payees have long been concerned about the identity of the payor and the sufficiency of funds when accepting drafts, checks, or check-like instruments for the exchange of goods and services. Each year, approximately five billion dollars is lost by merchants in the United States alone due to uncollectible drafts. Of this large sum, 41% is due to closed accounts or fraudulent presentation.

Many systems have been developed to minimize the risk to the merchant that the draft will not be honored. The Bezy, et al. U.S. Pat. No. 5,703,344 is such a system. However, that patent does not have an identification method of the payor as part of its system. Instead, it is a network connection system from the merchant to the payor bank to confirm the sufficiency of the funds to satisfy the transaction. Likewise, the Abecassis U.S. Pat. No. 5,426,281 is a transaction protection system for ensuring the sufficiency of fluids to cover drafts for purchases, and does not include a method of payor identification so as to prevent fraudulent presentation.

Of the three references above to prior art, only the Pare, Jr., et al. U.S. Pat. No. 6,192,142 is similar to this application in that it is also a method of identification of the payor as a means for protecting the merchant when accepting payment for goods sold. However, the Pare patent's use of biometric samples is a very intricate method and system that has the disadvantage of being impractical to implement on a wide scale basis. This is so because it requires a system of registration and central storing of biometric samples (fingerprints, iris image, etc . . . ) and then a method for the payee merchant's identification of a payor by comparison of the payor's biometric parameters with those that are stored.

It is of interest that merchants have used extensively the Bezy and the Abecassis patents to verify sufficiency of payor funds in conjunction with the widespread use of credit and debit cards. There has not been a comparable use of the Bezy and Abecassis patents to protect merchants and financial institutions in the negotiation of checks and other drafts. Likewise, the Pare biometric patent does not appear to have the same practical potential for use with checks and other drafts, that it might have with the use of credit cards. For example, many more financial institutions are issuing checks than institutions issuing credit and debit cards. As a result, the networking system for checks and other drafts is necessarily more complicated than a comparable system for credit cards. Consequently, these prior art patents have very little, if any, utility when it comes to their application to negotiable instrument transactions.

Admittedly, because it is a very accurate method for identification of the payor, the Pare patent provides protection against forgery. On the other hand, due to reasons discussed above, that patent is also the most difficult system and method to implement. Consequently, the Pare patent's allegations regarding it being practical, convenient, and easy to use, overlook considerations of cost effectiveness. For example, the practicality of the implementation of the Pare system and method is problematic when it comes to negotiable instruments. This is due to its complexity in requiring: (1) biometric samples to be taken and centrally stored; (2) a network between this data and the merchantibanks; and then, (3) a method to identify the payor by comparing the biometric samples with the biometric characteristics of the payor. All of this further requires optical reading devices at the point of sale with the merchant, along with the electronic equipment to communicate with and transfer this data to a central data base for verification.

On the other hand, the method of payor identification at the point of transaction of this invention, is more advantageous in that it is more affordable than the prior art, and at the same time, provides a flexible system that does not require the creation of a secure network for electronic transactions. In this regard, this invention requires no optical reading device (or any other mechanical equipment for that matter) at the point of negotiating the draft. Further, it eliminates the need for the payor to provide a biometric sample to the payor financial institutions.

Pare claims an advantage due to convenience to the payees (merchants) and financial institutions to make financial transactions. However, as explained above, it is not convenient or uncomplicated to set up that system. On the other hand, this claimed invention of payor identification is both: (1) convenient and simple to perform; but also, (2) much less costly or intricate to set up than the prior art. Specifically, the substance of the system involved in this invention applied for is to produce a negotiable instrument with an image of a government issued photographic identification of the payor superimposed on said negotiable instrument. This is clearly less costly to the financial institutions than the optical readers and other equipment needed for the system network used to implement the Pare patent.

It is further an objective of this invention to provide a system and method that eliminates the need for the payor to incur any delay in acceptance of the negotiable instrument. This is accomplished by being able to rapidly verifying the user's identity with a manual system simply by comparing the signature and description on the payor's government issued photographic identification card, with an image of that same government issued identification card that is superimposed on the payor's negotiable instrument.

As a result, the objectives to provide rapid, accurate and cost effective identification of payor so as to prevent fraudulent presentation of a negotiable instrument are satisfied by this claimed invention, but not by any of the prior art.

### SUMMARY

This invention satisfies the above objectives by providing a method and system for identification of the payor comprising the steps of: (1) reproducing the image of a photographic government issued identification card of the payor on the face of the payor's negotiable instrument; (2) presentation of same to the payee/merchant by the payor; and, (3) verification by the payee/merchant that the payor is the same person identified on the negotiable instrument as the designated payor by comparison of the information contained on the payor's government issued photographic identification card with an image of said government issued photographic identification card that has been reproduced on the negotiable instrument being presented. This system and method of identification allows the payee merchant to, easily and at no expense, verify the identity of the payor at the point of the transaction, all before the payee relinquishes control over the services or goods being sold.

This manual system and method is an extremely practical method and system of preventing fraudulent presentation of negotiable instruments, all with a very low risk of identity theft. For example, it allows the transaction to be completed quickly and without the expenses or equipment necessary with more complicated verification systems. Further, this verification system and method is extremely difficult to fraudulently circumvent in that any impersonator of the payor in question must not only forge the payor's signature, and have acquired both the payor's government issued photographic identification along with the negotiable instruments in which the image of same have been superimposed, but further, said impersonator must also resemble the physical characteristics and photograph of the payor's government issued photographic identification card.

1. A method for identification of a payor of a negotiable instrument by a merchant payee, comprising the steps of:
(a) the step of the payor's financial institution preparing printed checks or other negotiable instruments for the payor's signature, superimposed with an identical image of the payor's government issued photographic identification card that is to used by the payor as identification when presenting said negotiable instrument to payee,
(b) the step of the payor presenting said negotiable instrument with an image of payor's government issued photographic identification superimposed, along with said government issued photographic identification card of the payor; and,
(c) the step of the merchant payee identifying the payor by verification of the identifying information on the negotiable instrument by comparison with that information on the photographic identification provided by the payor.

2. A system and method for enhancing the reliability of identifying the payor of a negotiable instrument at the point of transaction comprising:
(a) a government issued photographic identification card of the payor;
(b) an image of said government issued photographic identification card of the payor superimposed on the negotiable instrument to be presented for payment; and,
(c) comparison of the physical description, photographic image and signature of said payor on said government issued photographic identification card with the identical information superimposed on said negotiable instrument.

3. A system and method for preventing forgery and other fraudulent presentment of negotiable instruments comprising:
The image of a government issued photographic identification card of the payor superimposed on said negotiable instrument by the payor's financial institution (or their agent), so that when presented to merchant payee by the payor, the payor can be readily identified by comparing the information on said government issued photographic identification card that has been superimposed on the negotiable instrument, with that information on the payor's government issued photographic identification card being carried by the payor.
